(19) United States
(12) Patent Application Publication
(10) Pub. No.: US 2004/0121695 A1
(43) Pub. Date: Jun. 24, 2004

(54) Method for relocating spacers using inductive force

(75) Inventors: Wei-Yi Lin, Yunlin (TW); Ming-Chun Hsiao, Hsinchu (TW); Cheng-Chung Lee, Hsinchu (TW); Kang-Hung Liu, Hsinchu (TW); Ching-Hsiang Chan, Hsinchu (TW); Yang-Yi Fan, Taichung (TW); Hsin-Chun Chiang, Hsinchu (TW)

Correspondence Address: QUINTERO LAW OFFICE, 1617 BROADWAY, 3RD FLOOR, SANTA MONICA, CA, 90404, US

(73) Assignee: Industrial Technology Research Institute

(21) Appl. No.: 10/603,546

(22) Filed: Jun. 25, 2003

(30) Foreign Application Priority Data
Dec. 19, 2002 (TW) 91136683

(51) Int. Cl. H01J 9/00; H01J 9/24

(52) U.S. Cl. 445/24

(57) ABSTRACT

A method of relocating spacers using inductive attraction. A chuck employs the inductive attraction to lift field emission display (FED) spacers, wherein the spacers are provided with susceptibility to the employed attraction. The spacers are lifted by the chuck and relocated to a desired position. The inductive process uses a non-contact force, including electrostatic and magnetic forces.

### BACKGROUND OF THE INVENTION

1. Field of the Invention

The present invention relates to positioning spacers in the manufacturing process for flat panel displays (FPD), and more specifically to use of a non-contact force (force at a distance) to position spacers on a desired position of field emission displays (FED).

2. Description of the Related Art

In the technological procedure of manufacturing flat panel display, spacers are used to keep a specific distance between an anode plate and a cathode plate.

Field emission display (FED) is a kind of flat panel display attracting intense notice in recent years. The main reason is that it not only has the thin and light characteristics of a liquid crystal display (LCD), but also the high brightness and self emission advantages of cathode ray tube (CRT) displays.

The distance between the cathode plate and the anode plate relates directly to the voltage of the field emission. The spacers are used to keep the space between the cathode plate and the anode plate even. When the two plate package is subjected to vacuum, the pressure between the upper and lower plates has to be less than 10 torr to avoid the field emission electrons being affected by residual gas. In this situation, the upper and lower plates reach a condition of intense vacuum, and the space will not be even. If the space between the two plates is not even, it will impact quality and lifetime of the display. Putting spacers between the two plates can effectively keep the space even and therefore maintain the electron field homogeneity and improve vacuum efficiency.

The traditional method of positioning spacers in the flat panel display is to use a mechanical arm to grasp spacers. The mechanical arms use two or more contact points to position spacers in a desired location with contact forces. This method is not easy because the arms have to align the spacers, lengthening the processing time and slowing down production. In addition, the spacers are easily damaged in this process.

The thickness of the spacers' cross section directly affects the resolution of display (the cross sections of spacers are non-emission area). Therefore, using spacers of high aspect ratio is a popular trend in the production of field emission display.

The spacers are gradually reduced to a very thin profile, such that the method using mechanical arms is not suitable. Vacuum chuck (adsorption) technology is also applied to several processes in production of flat panel display such as the absorption of glass substrates and electrode boards. Even though vacuum chuck technology can avoid the damage to adsorbed substrates, it cannot be applied to grasping spacers, since the spacers form comb or grid shapes; their hollow structure and the smaller width (less than 100 μm) do not provide adequate flat surface for vacuum chuck contact. Thus, vacuum chuck technology is not used extensively in spacer positioning for field emission display.

### SUMMARY OF THE INVENTION

Accordingly, the main object of the present invention is to provide an inductive procedure that improves on conventional contact procedures to position display spacers. The inductive attraction used are non-contact forces, comprising magnetic forces and electrostatic forces.

In order to achieve the above object, the present invention provides a method of relocating spacers using inductive attraction. The procedures involved use inductive attraction such as magnetic force and electrostatic force to position display spacers. Using inductive attraction prevents the structure of spacers from being damaged, saves time, and accelerates the production rate of field emission display by eliminating the need for spacers to be positioned before relocation. The present invention includes providing attractable spacers, using an inductive procedure (either magnetic or electrostatic procedure) with an inductive chuck to position (attract) spacers, and re-positioning the spacers in a desired location of a substrate using the inductive chuck.

### BRIEF DESCRIPTION OF THE DRAWINGS

The present invention can be more fully understood by reading the subsequent detailed description in conjunction with the examples and references made to the accompanying drawings, wherein:

FIG. 1A through 1C are schematic diagrams of the spacers using the inductive electrostatic method;

FIG. 2 is a schematic diagram of a spacer with magnetic materials attached thereto;

FIG. 3 is a schematic diagram of a spacer with magnetic materials deposited thereon;

FIG. 4A˜4C are schematic diagrams illustrating the use of inductive magnetic method to position the spacers;

FIG. 5 is cross section of FIG. 1C along line 5-5′.

### DETAILED DESCRIPTION OF THE INVENTION

The present invention relates to a method of using inductive attraction to position spacers in the process of manufacturing field emission displays. This inductive procedure uses magnetic or electrostatic forces to position or attract spacers rather than using direct contact.

The substrate to receive spacers can be a flat panel display's upper or lower plates, such as a field emission display's anode or cathode plates.

The spacers between the anode and cathode plates maintain even space between the two boards. Therefore space between the two boards under intense vacuum pressure (less than 10−⁶ torr) can be even, so that the display quality is not affected.

The inductive method uses non-contact forces including magnetic or electrostatic forces to position or attract spacers.

Inductive or attractable spacers are spacers that can be attracted by inductive attraction (such as magnetic or electrostatic forces). The inductive spacers are usually spacers composed totally or partially of materials that can be attracted by inductive attraction. Spacers can use magnetic (Fe, Co, Ni, or alloys thereof) or electrostatic materials for entire or partial composition, others can be structured in two or more layers with at least one layer of electrostatic or magnetic material, or have magnetic materials deposited thereon. Spacers can also be made of dielectric, ceramic, or glass materials.

The spacers applied to field emission display that use magnetic adsorption procedures can be cylindrical, X-, I-, L-, or bar-shaped or a combination thereof. The spacers can also be structured with two or more cross-points such as comb, lattice, grid, or zig-zag shaped or a combination thereof.

The spacers applied to field emission display using electrostatic adsorption procedures can be cylindrical, X-, I-, L-, or bar-shaped, comb, lattice, grid, or zig-zag shaped or a combination thereof. Among the different shapes, those structures with two or more cross points are preferred.

When grabbing spacers with the method according to the present invention, the spacers can be precisely positioned on a substrate using an alignment step. A charge-coupled device (CCD) or alignment marks can be used to detect the exact required relative positions of the chuck and the substrate.

The following embodiments are intended to illustrate the invention more fully without limiting their scope, since numerous modifications and variations will be apparent to those skilled in this art.

### First Embodiment

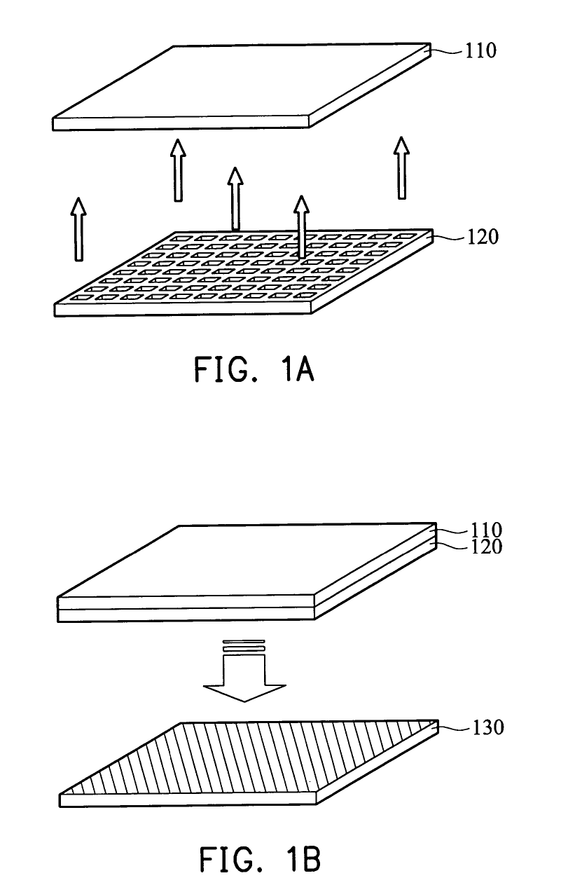

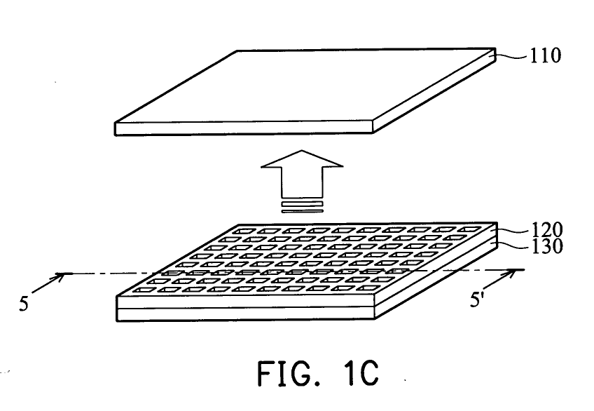

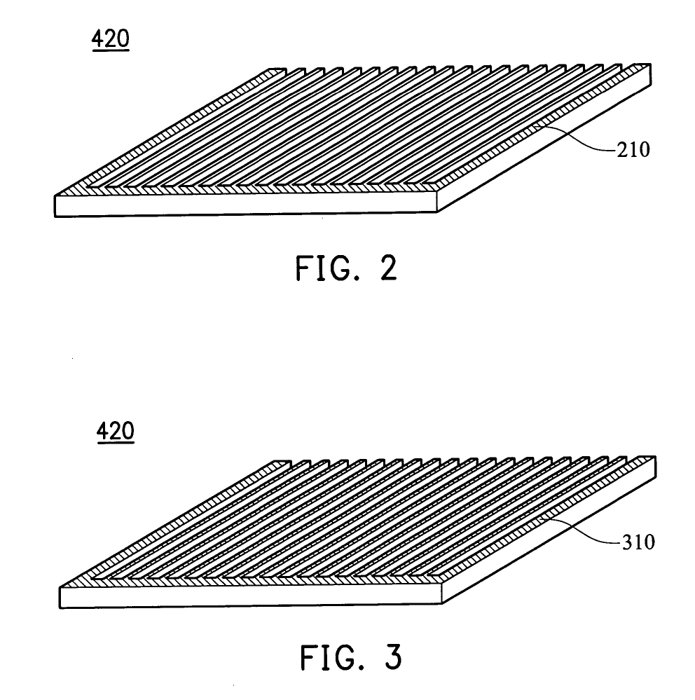

FIGS. 1A through 1C show the steps of positioning spacers using the inductive electrostatic method. In FIG. 1A, the grid shaped rubber spacer 120 (with the thickness of 1000 μm) is put on a flat surface with its adopted face upward. It is then attracted to an electrified, gradually descending ceramic electrostatic chuck 110.

In FIG. 1B, a substrate, preferably comprising the display's upper or lower plate, is provided. In this embodiment, it is a field emission display's anode plate 130 with phosphor layers 132 and black matrix layers 134. Next, the spacer 120 is lifted by the attractive chuck 110 and aligned precisely with the field emission display's anode plate 130. A Charge-Coupled Device (CCD) can check the alignment marks on the attractive chuck 110 (or spacer 120) and the field emission display's anode plate 130. The alignment step can also be accomplished by a spacer alignment machine.

In FIG. 1C, the voltage supply to the attractive chuck 110 is interrupted and the spacer 120 is released onto the black matrix layer 134 after precise alignment. The attractive chuck is removed, completing the process.

### Second Embodiment

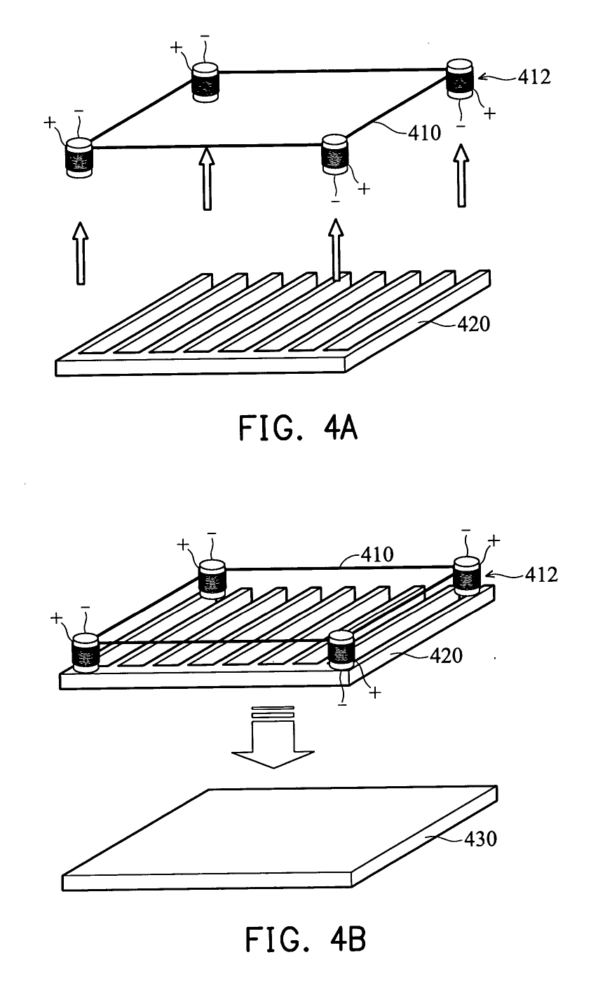

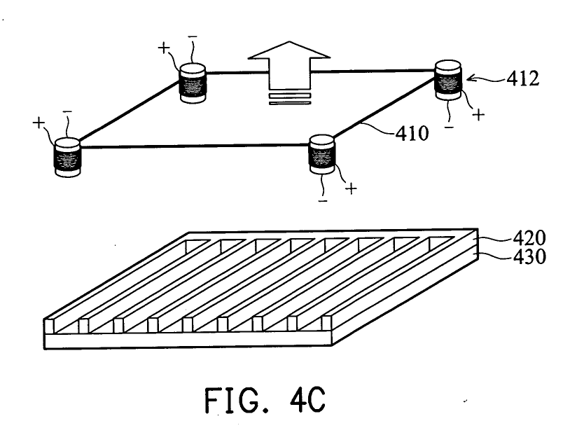

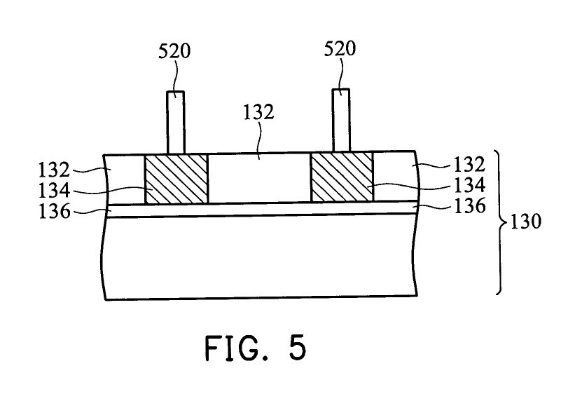

FIG. 4A through FIG. 4C show the steps of positioning spacers used in the inductive magnetic method. In FIG. 4A, a comb shaped, dielectric spacer 420 with attached or deposited magnetic materials thereon (including Fe, Co, Ni, or alloys thereof) is provided with its adopted face upward, as shown in FIG. 2 and FIG. 3. Next, an electromagnetic chuck 410 with several magnetic metal bands 412 thereon is electrified and then gradually lowered to attract the spacer 420 by means of the aforementioned magnetic materials thereon. The magnetic force of the electromagnetic chuck 410 can be adjusted by the amount of electric current.

In FIG. 4B, a substrate preferably comprising the display's upper or lower plate is provided. In this embodiment, it is a field emission display's cathode plate 430. Next, the spacer 420 is lifted by the electromagnetic chuck 410 and aligned precisely with the field emission display's anode plate 130. A Charge-Coupled Device (CCD) can check the alignment marks on the attractive chuck 410 (or spacer 420) and the field emission display's cathode plate 430. The alignment step can also be accomplished by a spacer alignment machine.

In FIG. 4C, the voltage supply to the electromagnetic chuck 410 is interrupted and the spacer 420 is released onto the desired position of the cathode plate 430 after precise alignment. The electromagnetic chuck 410 is then removed, completing the process.

In summary, compared with previous technology, the present invention has the following advantages. The invention's use of an inductive procedure (magnetic or electrostatic adsorption) rather than contact forces to position (adsorb) spacers takes less time to reposition spacers, speeding throughput. The inventive procedure avoids damage to the spacers by contact forces keeping the spacers intact. Finally, the spacers are not restricted to specific structures with the attractive chuck can be exchanged according differing spacer sizes and shapes.

Although the present invention has been particularly shown and described above with reference to two specific embodiments, it is anticipated that alterations and modifications thereof will no doubt become apparent to those skilled in the art. It is therefore intended that the following claims be interpreted as covering all such alteration and modifications as fall within the true spirit and scope of the present invention. What is claimed is:

1. A method of repositioning display spacers using inductive attraction, comprising:
providing spacers susceptible to inductive attraction;
providing an inductive chuck to attract the spacers;
providing a substrate;
using the inductive chuck to position the spacers in desired positions on the substrate.

2. The method as claimed in claim 1, wherein the spacers are spacers of a field emission display.

3. The method as claimed in claim 1, wherein the inductive attraction comprises non-contact forces (force at a distance).

4. The method as claimed in claim 1, wherein the inductive attraction comprises magnetic forces.

5. The method as claimed in claim 4, wherein the magnetic forces generate magnetic forces through natural magnets, artificial magnets, electromagnetic systems, or a combination thereof.

6. The method as claimed in claim 4, wherein the spacers are made of magnetic materials.

7. The method as claimed in claim 4, wherein the spacers have magnetic materials deposited thereon.

8. The method as claimed in claim 4, wherein the spacers have magnetic materials attached thereto.

9. The method as claimed in claim 5, wherein the spacers have two or more layers, at least one of which is made of magnetic materials.

10. The method as claimed in claim 1, wherein the inductive attraction comprises electrostatic forces.

11. The method as claimed in claim 10, wherein the spacers are made of electrostatic materials.

12. The method as claimed in claim 10, wherein the spacers have electrostatic materials attached thereto.

13. The method as claimed in claim 10, wherein the spacers have two or more layers, at least one of which is made of electrostatic materials.

14. The method as claimed in claim 10, wherein the spacers are made of metal, alloy, dielectric, ceramic, or glass materials, or a combination thereof.

15. The method as claimed in claim 1, wherein the spacers are cylindrical, X-, I-, L-, or bar-shaped or a combination thereof.

16. The method as claimed in claim 1, wherein the shapes of spacers have two or more cross points, comprising comb, lattice, grid, or zig-zag shapes or a combination thereof.

17. The method as claimed in claim 1, wherein the substrate is the anode plate of a flat panel display.

18. The method as claimed in claim 1, wherein the substrate is the anode plate of a field emission display.

19. The method as claimed in claim 1, wherein the substrate is the cathode plate of a flat panel display.

20. The method as claimed in claim 1, wherein the substrate is the cathode plate of a field emission display.

21. The method as claimed in claim 1, further comprising using an alignment step when locating the spacer onto a desired position on the substrate.

22. The method as claimed in claim 21, wherein the alignment step comprises use of Charge-Coupled Device (CCD) and alignment marks.
